(19) United States
(12) Patent Application Publication
(10) Pub. No.: US 2021/0364616 A1
(43) Pub. Date: Nov. 25, 2021

(54) RADAR SYSTEM AND COMPUTER-IMPLEMENTED METHOD FOR RADAR TARGET DETECTION

(71) Applicant: Hertzwell Pte. Ltd., Singapore (SG)

(72) Inventors: Guohua Wang, Singapore (SG); Kumar Vijay Mishra, Adelphi, MD (US); Bhaskar Jyoti Dutta, Singapore (SG)

(21) Appl. No.: 16/880,460

(22) Filed: May 21, 2020

(51) Int. Cl. G01S 13/06; G01S 7/40; G01S 13/50

(52) U.S. Cl. CPC G01S 13/06; G01S 13/505; G01S 7/4026

(57) ABSTRACT

A computer-implemented method for radar target detection and radar systems includes executing via one or more processors: transmitting a signal from transmit antennas to receive antennas, each transmit antenna configured to alternately transmit at first and second pulse repetition frequencies, each frame of the signal including sub-frames, each sub-frame including pulses from the transmit antennas in a staggered arrangement; performing range compression on the pulses in each frame to generate range cells; performing Doppler processing on each range cell to generate range-Doppler (RD) maps for the transmit antennas; integrating the RD maps to generate an integrated RD map; detecting presence of a target from the integrated RD map; estimating range and velocity of the detected target; estimating direction-of-arrival (DOA) of the detected target; and generating a point cloud of the detected target by computing Cartesian coordinates of the detected target from the range and the DOA of the detected target.

### TECHNICAL FIELD

The present invention relates to the field of radar technology and more particularly to a radar system and a computer-implemented method for radar target detection.

### BACKGROUND

Frequency-Modulated Continuous Wave (FMCW) radar has diverse applications in both civilian and military operations. It is one of the most popular radar systems for autonomous navigation of vehicles. In automotive applications, FMCW signals are employed in conjunction with a multiple-input multiple-output (MIMO) radar, which employs many transmit and receive antennas, to exploit waveform diversity for improving radar performance. A common problem associated with the FMCW radar is that maximum unambiguous velocity is limited by pulse repetition interval (PRI) of a transmitted waveform. The problem is further aggravated when the FMCW radar is operated in MIMO mode with either Time Division Multiplexing (TDM) or Code Division Multiplexing (CDM) waveforms because these modes increase the effective PRI. Hence, it would be desirable to provide a radar system and a computer-implemented method for radar target detection that extends the maximum unambiguous velocity in such radar systems.

### SUMMARY

Accordingly, in a first aspect, the present disclosure provides a computer-implemented method for radar target detection. The method includes executing via one or more processors the steps of: transmitting a signal from a plurality of transmit antennas to a plurality of receive antennas, each of the transmit antennas being configured to alternately transmit at a first pulse repetition frequency (PRF) and a second PRF, each frame of the signal including a number of sub-frames, each sub-frame including a plurality of pulses from respective ones of the transmit antennas in a staggered arrangement; performing range compression on the pulses in each frame of the signal received by the receive antennas to generate a plurality of range cells; performing Doppler processing on each of the range cells to generate a plurality of range-Doppler (RD) maps for respective ones of the transmit antennas; integrating the RD maps of the transmit antennas to generate an integrated RD map; detecting presence of a target from the integrated RD map; estimating a range and a velocity of the detected target; estimating a direction-of-arrival (DOA) of the detected target; and generating a point cloud of the detected target by computing Cartesian coordinates of the detected target from the range and the DOA of the detected target.

In a second aspect, the present disclosure provides a radar system including a plurality of transmit antennas and a plurality of receive antennas, the transmit antennas being configured to transmit a signal to the receive antennas, each of the transmit antennas being configured to alternately transmit at a first pulse repetition frequency (PRF) and a second PRF, each frame of the signal comprising a number of sub-frames, each sub-frame comprising a plurality of pulses from respective ones of the transmit antennas in a staggered arrangement. The radar system further includes one or more processors and a non-transitory computer-readable memory storing computer program instructions executable by the one or more processors to perform operations for radar target detection. The operations include: performing range compression on the pulses in each frame of the signal received by the receive antennas to generate a plurality of range cells; performing Doppler processing on each of the range cells to generate a plurality of range-Doppler (RD) maps for respective ones of the transmit antennas; integrating the RD maps of the transmit antennas to generate an integrated RD map; detecting presence of a target from the integrated RD map; estimating a range and a velocity of the detected target; estimating a direction-of-arrival (DOA) of the detected target; and generating a point cloud of the detected target by computing Cartesian coordinates of the detected target from the range and the DOA of the detected target.

Other aspects and advantages will become apparent from the following detailed description, taken in conjunction with the accompanying drawings, illustrating by way of example the principles of the invention.

### BRIEF DESCRIPTION OF THE DRAWINGS

Embodiments will now be described, by way of example only, with reference to the accompanying drawings, in which:

FIG. 1 is a schematic block diagram of a radar system in accordance with one or more embodiments;

FIG. 2 is a schematic diagram illustrating transmit and receive antenna array configurations for the radar system of FIG. 1;

FIG. 3 is a schematic flow diagram illustrating a computer-implemented method for radar target detection in accordance with one or more embodiments;

FIG. 4 illustrates an example of a transmission scheme employed by the radar system of FIG. 1;

FIG. 5 is a schematic diagram illustrating data flow during the steps of performing range compression and Doppler processing in the radar target detection method of FIG. 3;

FIG. 6 is a schematic flow diagram illustrating a Doppler processing method in accordance with one or more embodiments;

FIG. 7 is a graph showing Doppler estimation results from the Doppler processing method of FIG. 6;

FIG. 8 is a schematic diagram illustrating data flow during a Doppler processing step of FIG. 3;

FIG. 9 is a schematic diagram illustrating data flow during the step of range-Doppler (RD) integration in the radar target detection method of FIG. 3;

FIG. 10 is a schematic flow diagram illustrating a method for estimating a direction-of-arrival (DOA) of a detected target in accordance with one or more embodiments;

FIG. 11 is a schematic diagram illustrating data flow during the DOA estimation method of FIG. 10; and

FIG. 12 is a schematic block diagram illustrating various functionalities of the radar system of FIG. 1.

### DETAILED DESCRIPTION

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

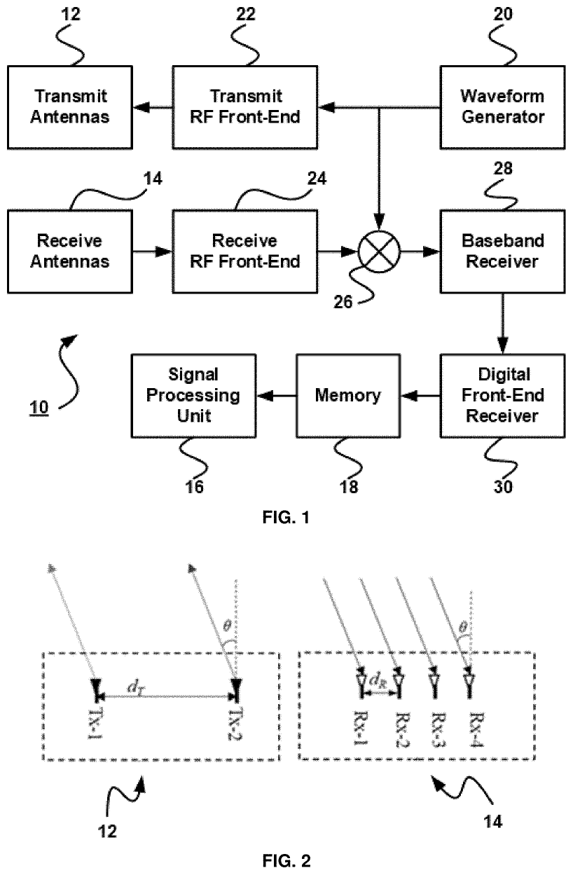

Referring now to FIG. 1, a radar system 10 is shown. The radar system 10 includes a plurality of transmit antennas 12 and a plurality of receive antennas 14. The transmit antennas 12 are configured to transmit a signal to the receive antennas 14. Each frame of the signal includes a number of sub-frames, each sub-frame including a plurality of pulses from respective ones of the transmit antennas 12 in a staggered arrangement. Each of the transmit antennas 12 is configured to alternately transmit at a first pulse repetition frequency (PRF) and a second PRF. The radar system 10 also includes one or more processors 16 and a non-transitory computer-readable memory 18 storing computer program instructions executable by the one or more processors 16 to perform operations for radar target detection. The operations performed by the one or more processors 16 include performing range compression on the pulses in each frame received by the receive antennas to generate a plurality of range cells, performing Doppler processing on each of the range cells to generate a plurality of range-Doppler (RD) maps for respective ones of the transmit antennas, integrating the RD maps of the transmit antennas to generate an integrated RD map, detecting presence of a target from the integrated RD map, estimating a range and a velocity of the detected target, estimating a direction-of-arrival (DOA) of the detected target, and generating a point cloud of the detected target by computing Cartesian coordinates of the detected target from the range and the DOA of the detected target.

Multiple identical transmit channels may be provided by the radar system 10. The transmit channels include a waveform generator 20 configured to generate a Frequency-Modulated Continuous Wave (FMCW) waveform with predetermined signal parameters and a transmit radio frequency (RF) front-end 22 configured to modulate the waveform generated by the waveform generator 20 to a dedicated RF frequency with a predetermined power for transmission by the transmit antennas 12. Each transmit channel may be connected to one (1) dedicated transmit antenna 12 through the transmit RF front-end 22. The transmit channels may operate in either Time Division Multiplexing (TDM) or Code Division Multiplexing (CDM) mode. The waveform generator 20 may generate other waveforms in alternative embodiments.

The radar system 10 may include multiple identical receive channels for signal reception. Each receive channel may be connected to one (1) receive antenna 14 via a receive radio frequency (RF) front-end 24. The receive RF front-end 24 may include a bandpass filter (not shown) for out-of-RF-band interference suppression and a low noise amplifier (not shown) to amplify signal power in an RF domain.

An RF mixer 26 may be provided to mix a received RF signal with a copy of the waveform to be transmitted before the received RF signal is received by a baseband receiver 28 and a digital front-end receiver 30. The baseband receiver 28 may include a bandpass filter amplifier (not shown) and an analog-to-digital converter (ADC) (not shown). The digital front-end receiver 30 may include a plurality of digital decimation filters (not shown) to reduce data rate and other modules (not shown) to compensate for direct current (DC) offset, receiver gain imbalance and phase imbalance.

Output from the digital front-end receiver 30 may be passed to the on-chip memory 18 for either data buffering or temporary storage and then fed to the one or more processors 16 in a signal processing unit. The memory 18 may also be used for storage of intermediate data produced during signal processing steps. The signal processing unit 16 is configured to accept raw radar data as input and perform operations such as range compression, Doppler estimation, angle estimation, point cloud generation, tracking, and target classification. Signal processing may be implemented on field programmable gate array (FPGA), digital signal processor (DSP) and/or more advanced computational devices such as graphic processing unit (GPU). Some signal processing operations may be carried out on-board a main radar processor and the rest on peripheral devices like micro-controller unit (MCU).

The one or more processors 16 (which may be referred to as a central processor unit or CPU) may additionally be in communication with input/output (I/O) devices (not shown) and network connectivity devices (not shown). The one or more processors 16 may be implemented as one or more CPU chips.

The memory 18 may include secondary storage (not shown), read only memory (ROM) (not shown) and random access memory (RAM) (not shown).

It is understood that by programming and/or loading executable instructions onto the radar system 10, at least one of the CPU 16, the RAM 18 and the ROM 18 are changed, transforming the radar system 10 in part into a particular machine or apparatus having the novel functionality taught by the present disclosure. It is fundamental to the electrical engineering and software engineering arts that functionality can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the radar system 10 is turned on or booted, the CPU 16 may execute a computer program or application. For example, the CPU 16 may execute software or firmware stored in the ROM 18 or the RAM 18. In some cases, on boot and/or when the application is initiated, the CPU 16 may copy the application or portions of the application from the secondary storage 18 to the RAM 18 or to memory space within the CPU 16 itself, and the CPU 16 may then execute instructions that the application is comprised of In some cases, the CPU 16 may copy the application or portions of the application from memory accessed via the network connectivity devices or via the I/O devices to the RAM 18 or to memory space within the CPU 16, and the CPU 16 may then execute instructions that the application is comprised of. During execution, an application may load instructions into the CPU 16, for example load some of the instructions of the application into a cache of the CPU 16. In some contexts, an application that is executed may be said to configure the CPU 16 to do something, for example, to configure the CPU 16 to perform the function or functions promoted by the subject application. When the CPU 16 is configured in this way by the application, the CPU 16 becomes a specific purpose computer or a specific purpose machine.

The one or more processors 16 execute instructions, codes, computer programs, scripts which it accesses from hard disk, floppy disk, optical disk (these various disk-based systems may all be considered secondary storage 18), flash drive, ROM 18, RAM 18, or the network connectivity devices. While instructions may be discussed as executed by a processor, the instructions may be executed simultaneously, serially, or otherwise executed by one or multiple processors.

The secondary storage 18 is typically comprised of one or more disk drives or tape drives and is used for non-volatile storage of data and as an over-flow data storage device if RAM 18 is not large enough to hold all working data. Secondary storage 18 may be used to store programs which are loaded into RAM 18 when such programs are selected for execution. The ROM 18 is used to store instructions and perhaps data which are read during program execution. ROM 18 is a non-volatile memory device which typically has a small memory capacity relative to the larger memory capacity of secondary storage 18. The RAM 18 is used to store volatile data and perhaps to store instructions. Access to both ROM 18 and RAM 18 is typically faster than to secondary storage 18. The secondary storage 18, the RAM 18, and/or the ROM 18 may be referred to in some contexts as computer readable storage media and/or non-transitory computer readable media. A dynamic RAM embodiment of the RAM 18, likewise, may be referred to as a non-transitory computer readable medium in that while the dynamic RAM receives electrical power and is operated in accordance with its design, for example during a period of time during which the radar system 10 is turned on and operational, the dynamic RAM stores information that is written to it. Similarly, the one or more processors 16 may comprise an internal RAM, an internal ROM, a cache memory, and/or other internal non-transitory storage blocks, sections, or components that may be referred to in some contexts as non-transitory computer readable media or computer readable storage media.

I/O devices may include cameras, printers, video monitors, liquid crystal displays (LCDs), plasma displays, touch screen displays, keyboards, keypads, switches, dials, mice, track balls, voice recognizers, card readers, paper tape readers, or other well-known input devices. The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices may enable the one or more processors 16 to communicate with the Internet or one or more intranets. With such a network connection, it is contemplated that the one or more processors 16 might receive information from the network, or might output information to the network in the course of performing method steps described below. Such information, which is often represented as a sequence of instructions to be executed using the one or more processors 16, may be received from and outputted to the network, for example, in the form of a computer data signal embodied in a carrier wave. Such information, which may include data or instructions to be executed using the one or more processors 16 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

In an embodiment, the radar system 10 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the radar system 10 to provide the functionality of a number of servers that is not directly bound to the number of computers in the radar system 10. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed may be provided as a computer program product. The computer program product may comprise one or more computer readable storage medium having computer usable program code embodied therein to implement the functionality disclosed. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the radar system 10, at least portions of the contents of the computer program product to the secondary storage 18, the ROM 18, the RAM 18 and/or other non-volatile memory and volatile memory of the radar system 10. The one or more processors 16 may process the executable instructions and/or data structures in part by directly accessing the computer program product, for example by reading from a CD-ROM disk inserted into a disk drive peripheral of the radar system 10. Alternatively, the one or more processors 16 may process the executable instructions and/or data structures by remotely accessing the computer program product, for example by downloading the executable instructions and/or data structures from a remote server through the network connectivity devices. The computer program product may comprise instructions that promote the loading and/or copying of data, data structures, files, and/or executable instructions to the secondary storage 18, the ROM 18, the RAM 18, and/or to other non-volatile memory and volatile memory of the radar system 10.

Referring now to FIG. 2, array configurations for the transmit antennas 12 and the receive antennas 14 of the radar system 10 are shown. In order to achieve a high resolution in angle estimation, the transmit antenna array 12 and the receive antenna array 14 may be configured in such a way that the requirement of a desirable resolution is satisfied. A rule-of-thumb is that the array design should satisfy the angular resolution requirement and be suitable for direction-of-arrival (DOA) estimation with appropriate signal processing algorithms. A one-dimensional array design to estimate an azimuth angle is illustrated in FIG. 2. Extension to two-dimensional array designs is similar.

In the embodiment shown, the receive antenna array 14 is designed to be a uniform linear array (ULA) with N representing a number of elements in the transmit antenna array 12 and M representing a number of elements in the receive antenna array 14. Inter-element spacing in the transmit antenna array 12 is represented by d_{T}, while inter-element spacing in the receive antenna array 14 is represented by d_{R}. d_{R} is typically half of operating wavelength in the receive antenna array 14. Additionally, arrangement may be made to ensure that the following is satisfied: d_{T}=Md_{R}. This arrangement of Tx and Rx arrays 12 and 14 ensures that multiple-input multiple-output (MIMO) processing is applied to improve the angular resolution. Based on the theory of multiple-input multiple-output (MIMO) radar, target echoes from different transmitters 12 are separable at any single receiver 14. Thus, signals at a given receive element 14 due to each transmit antenna 12 result in N transmit-receive channels. The signal at each receive antenna 14 has distinct phase information arising from different spatial locations of each receive antenna 14. The transmit antennas 12 also have different spatial positions, thereby leading to additional phase information in each transmit-receive channel. Overall, the N transmit antennas 12 and M receive antennas 14 form a virtual array of NM virtual transmit-receive channels.

A signal sₙ(t) from an n-th transmit (Tx) antenna 12 at time t may be defined by Equation (1):

sₙ(t)=aₙ(t)e^{j2πf}^{_{c}}^{t} (1)

where aₙ(t) represents a baseband transmit waveform, j represents an imaginary unit defined by j=\sqrt{−1} and f_{c} represents carrier frequency. The signal sₙ(t) impinges on a target and is reflected toward the radar system 10.

An echo signal sₘₙ(t) at an m-th receive (Rx) antenna 14 may be defined by Equation (2):

sₘₙ(t)=sₙ(t−τₘₙ)=aₙ(t−τₘₙ)e^{j2πf}^{_{c}}^{(t-τ}^{ₘₙ}⁾ (2)

where τₘₙ represents bistatic time delay from transmitter 12 via target to receiver 14. In practice, since the target is at a far range with respect to transmit (Tx) and receive (Rx) antenna separation, the receive signal model under narrow band assumption may be defined by Equation (3):

sₘₙ(t)=sₙ(t−τₘₙ)=aₙ(t−τ₀)e^{j2πf}^{_{c}}^{t}e^{-j2πf}^{_{c}}^{τ}^{ₘₙ} (3)

where τ₀ represents bistatic range-time delay from a reference transmitter 12 to the target and back from the target to a reference receiver 14, the reference transmitter 12 and the reference receiver 14 being used to represent delay in the waveform for all Tx-Rx pairs. After mixing (ignoring noise components and interference due to hardware imperfections), the received signal xₘₙ(t) may be defined by Equation (4):

xₘₙ(t)=bₙ(t−τ₀)e^{-j2πf}^{_{c}}^{τ}^{₀}e^{-j2πf}^{_{c}}^{Δ}^{ₘₙ} (4)

where bₙ(t) represents the waveform after mixing and Δₘₙ represents a relative time delay between the reference Tx-Rx pair and the (m, n)-th Tx-Rx pair and may be represented by Equation (5):

τₘₙ=τ₀+Δₘₙ (5)

For a uniform linear array (ULA), the relative delay Δₘₙ may be defined by Equation (6):

$${Δ}_{m n} = \frac{( m - 1 ) {d}_{R} + ( n - 1 ) {d}_{T}}{c} sin ( θ ) \qquad ( 6 )$$

where d_{T} represents an inter-element spacing in the transmit (Tx) antenna array 12, d_{R} represents an inter-element spacing in the receive (Rx) antenna array 14, c represents a speed of light in a propagation medium and θ represents the DOA of the target. From Equation (6), Tx and Rx arrays may be designed using an ULA of M elements as the receive (Rx) antenna array 14 and elements of the transmit (Tx) antenna array 12 may have a spacing of at least Md_{R} to avoid an overlap. Moreover, to reduce grating lobes (or spatial aliasing), the spacing in the receive (Rx) antenna array 14 may be half wavelength and the spacing in the transmit (Tx) antenna array 12 may be M times of half wavelength. For illustrative purposes only, the transmit (Tx) antenna array 12 is shown as being N=2 and the receive (Rx) antenna array 14 is shown as being M=4 in FIG. 2. The receive (Rx) antennas 14 are separated by half wavelength and the transmit (Tx) antennas 12 are separated by twice of wavelength. The overall virtual array thus has NM=8 elements with half wavelength spacing.

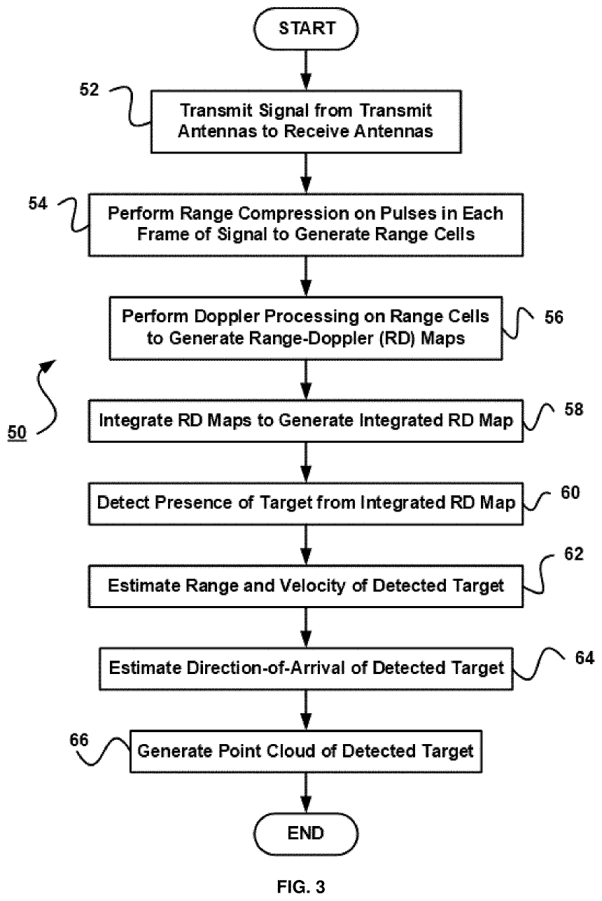

Having described radar system architecture and hardware of the radar system 10, a computer-implemented method 50 for radar target detection employing the radar system 10 of FIG. 1 will now be described with reference to FIG. 3.

Referring now to FIG. 3, a computer-implemented method 50 for radar target detection is shown. The method 50 for radar target detection may be executed on one or more processors 16.

The method 50 begins at step 52 by transmitting a signal from a plurality of transmit antennas 12 to a plurality of receive antennas 14. Each of the transmit antennas 12 is configured to alternately transmit at a first pulse repetition frequency (PRF) and a second PRF. Each frame of the signal includes a number of sub-frames and each sub-frame includes a plurality of pulses from respective ones of the transmit antennas 12 in a staggered arrangement.

The signal is transmitted according to a Time Division Multiplexing (TDM) staggered PRF co-pulsing scheme, in which the transmitter elements transmit staggered PRF pulse sequences in order to achieve a desired maximum unambiguous velocity. The TDM staggered PRF co-pulsing transmit scheme employed by the radar system 10 has the following characteristics: i) each frame consists of multiple sub-frames such that the number of sub-frames is an even number; ii) in each sub-frame, the transmission is conducted in a Time Division Multiplexing (TDM) mode across all the transmit antennas 12 using the same PRF; iii) two (2) PRFs are designed to achieve maximum unambiguous velocity; iv) the (2) PRFs alternate between the sub-frames; v) a fixed pulse duration is used for all the pulses although the pulse repetition interval may vary between sub-frames; and vi) the time duration for one (1) frame may be determined by velocity resolution.

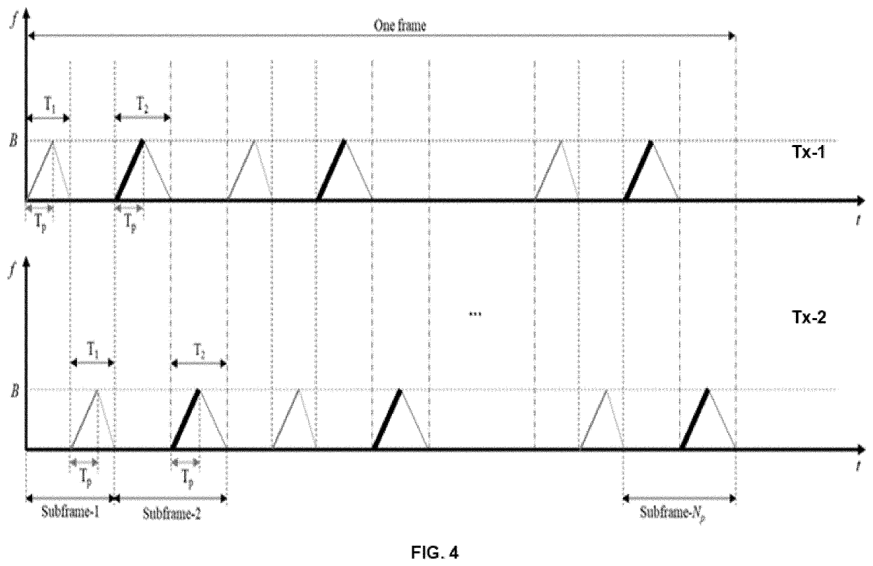

Referring now to FIG. 4, an example of a transmission scheme employed by the radar system 10 is shown. In this example, signal waveforms are transmitted according to a Time Division Multiplexing (TDM) staggered pulse repetition frequency (PRF) co-pulsing scheme using two (2) transmit (Tx) antennas 12.

In particular, a first Tx antenna Tx-1 transmits a first pulse of duration Tₚ at a first pulse repetition interval (PRI) of T₁ and this is followed by transmission of a second first pulse of duration Tₚ at the first PRI T₁ by a second Tx antenna Tx-2. These two (2) first pulses from the first and second Tx antennas Tx-1 and Tx-2 make up a first sub-frame with a pulse repetition frequency (PRF) of 1/T₁.

The first Tx antenna Tx-1 then transmits a second pulse of duration Tₚ at a second PRI of T₂ and this is followed by the second Tx antenna Tx-2 transmitting a second pulse of duration Tₚ at the second PRI of T₂. The two (2) second pulses from the first and second Tx antennas Tx-1 and Tx-2 make up a second sub-frame. All transmitted signals, irrespective of the PRFs employed, have identical pulse duration Tₚ.

This scheme of transmission is repeated until the last sub-frame. In this manner, two (2) PRFs are transmitted one after the other, the two PRFs being staggered on a sub-frame basis. Each sub-frame consists of a TDM transmission of pulses from different transmit antennas Tx-1 and Tx-2. In each sub-frame, a TDM is adopted with a fixed PRF.

The two (2) PRFs are chosen in such a way that (a) maximum velocity is extended directly to a desirable value, and (b) a desired Doppler is reached based on two PRFs and the number of sub-frames. Maximum unambiguous velocity vₘₐₓ, while using these two PRFs, may be defined by Equation (7):

$${v}_{m ax} = \frac{λ}{4} \frac{1}{N ( {T}_{1} - {T}_{2} )} \qquad ( 7 )$$

where λ represents a wavelength of the signal, N represents a total number of transmit antenna elements, T₁ represents a first pulse repetition interval (PRI) of the first PRF, and T₂ represents a second PRI of the second PRF. As can be seen from Equation (7), the maximum velocity vₘₐₓ is inversely proportional to a difference of the PRIs T₁ and T₂. The number of sub-frames Nₚ in each frame of the signal to meet a predetermined Doppler resolution σᵥ may be determined by Equation (8):

$${N}_{p} = \frac{λ}{N {σ}_{v} ( {T}_{1} + {T}_{2} )} . \qquad ( 8 )$$

where Nₚ is an even number as is required for Doppler processing. The whole frame thus consists of multiple sub-frames Nₚ.

Advantageously, the scheme of TDM co-pulsing of staggered PRFs is transitional-invariant so that a high-resolution signal processing method may be applied.

By the time the first pulse is transmitted from the first Tx antenna Tx-1, the receive antenna array 14 starts to receive the echo signal reflected back from the target environment. The signal impinging on the receive antenna array 14 goes through the entire receiver chain to the radar memory 18 for data storage and processing.

Referring again to FIG. 3, after the received signal is collected by the digital signal processor 16, range compression is performed at step 54 on the pulses in each frame of the signal received by the receive antennas 14 to generate a plurality of range cells. Range compression may be performed at step 54 by performing a fast Fourier transform (FFT) operation on the pulses in each frame of the signal received by the receive antennas 14. In alternative embodiments, range compression may be carried out by other spectrum analysis techniques such as, for example, a minimum variance distortionless response (MVDR) beamformer. Range compression may be conducted or performed at each receive channel 14 for every pulse transmitted from all the transmit antennas 12.

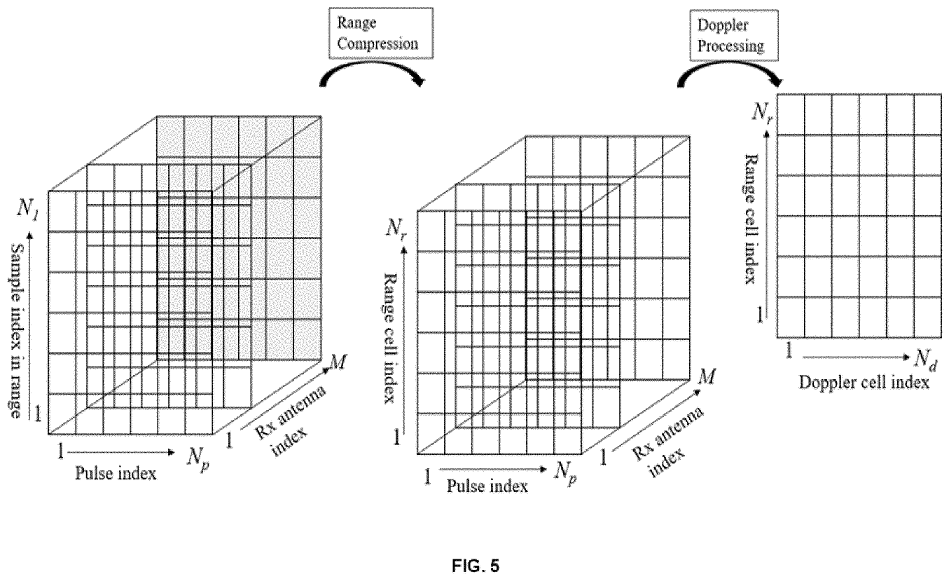

Referring now to FIG. 5, data flow for range-Doppler processing of a single data cube at the receive antenna array 14 for target echoes corresponding to the signal of a single transmit antenna 12 during the step of performing range compression 54 in the radar target detection method 50 is shown.

At each transmit (Tx) antenna 12, Nₚ pulses are transmitted. The corresponding reflected signals are collected by the receive antenna array 14 with each pulse resulting in N₁ samples determined by sampling frequency and pulse duration. Thus, for each transmit (Tx) antenna 12, the resulting raw radar data may be arranged in a data cube comprising M data matrices corresponding to M receive antennas 14. Each data matrix is of size N₁×Nₚ. As each data matrix consists of signal samples in range (fast-time) and pulse (slow-time) domain, each data matrix may be termed a range-pulse (RP) data matrix. For each data cube, range compression may be conducted on every RP data matrix. The data cube related to one (1) transmit (Tx) antenna 12 may have dimensions N₁×Nₚ×M shown in FIG. 5.

Range compression may be performed on every column of each RP data matrix in the data cube, each column corresponding to data samples of one pulse.

After range compression, each column may be of length Nᵣ, as per the size of an FFT. The resulting RP data matrix is now a range frequency-pulse matrix of size Nᵣ×Nₚ and the new data cube is of dimensions Nᵣ×Nₚ×M. For each range cell, the data is a space-time (ST) matrix of dimension Nₚ×M.

Referring again to FIG. 3, after range compression of all the pulses received at all the receive channels 14, Doppler processing is performed at step 56 on each of the range cells to generate a plurality of range-Doppler (RD) maps for respective ones of the transmit antennas. The Doppler processing step 56 may be carried out for every range bin or range cell on the range-compressed data. For each range cell, a data matrix is formed by arranging signals of the same transmitter 12 across all Rx array elements 14. In particular, the data matrix has M rows corresponding to M Rx antennas 14 and Nₚ columns corresponding to all the pulses transmitted from the same Tx antenna 12. The aim of Doppler processing is to generate a Doppler spectrum for each range cell based on the ST data matrix. Doppler processing may be used to estimate velocity.

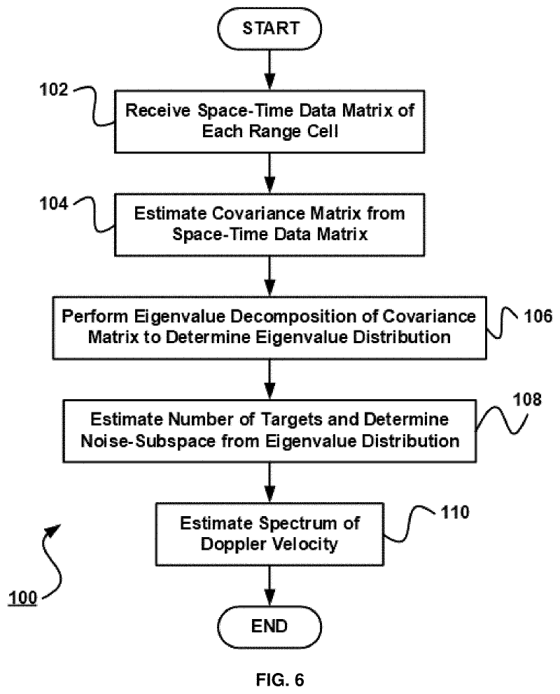

Referring now to FIG. 6, a Doppler processing method 100 will now be described. The method 100 begins at step 102 when a space-time data matrix xₙ(m) of each of the range cells as represented by Equation (9) is received:

$${x}_{n} ( m ) = [ {u}_{n} ( {v}_{1} ) … {u}_{n} ( {v}_{Q} ) ] [ \begin{matrix}{s}_{n} ( m , {θ}_{1} ) \\ ⋮ \\ {s}_{n} ( m , {θ}_{Q} )\end{matrix} ] + {n}_{n} ( m ) \qquad ( 9 )$$

where n represents an n-th transmit antenna 12, m represents an m-th receive antenna 14, Q represents a Q-th target, and uₙ(v_{Q}) represents a Doppler steering vector of the target and is defined by Equation (10):

$${u}_{n} ( {v}_{Q} ) = [ \begin{matrix}{e}^{- j 2 π {f}_{c} 2 {v}_{Q} {t}_{n} ( 1 ) / c} \\ {e}^{- j 2 π {f}_{c} 2 {v}_{Q} {t}_{n} ( 2 ) / c} \\ ⋮ \\ {e}^{- j 2 π {f}_{c} 2 {v}_{Q} {t}_{n} ( {N}_{p} - 1 ) / c}\end{matrix} ] \qquad ( 10 )$$

where v_{Q} represents a Doppler velocity of the target, j represents an imaginary unit, f_{c} represents carrier frequency, tₙ represents a Doppler sampling instant in slow-time domain, the slow-time domain being the time relevant to the timing of pulses within a coherent processing interval, and c represents a speed of light; sₙ(m, θ_{Q}) represents a target signal waveform and is defined by Equation (11):

sₙ(m,θ_{Q})=α_{Q}e^{-j2πf}^{_{c}}^{(n-1)d}^{_{T}}^{sin(θ}^{_{q}}^{)/c}e^{-j2πf}^{_{c}}^{(n-1)d}^{_{R}}^{sin(θ}^{_{q}}^{)/c} (11)

where θ_{Q} represents the DOA of the target, α_{Q} represents a complex amplitude of the target, d_{T} represents a transmit antenna spacing or inter-element spacing in a transmit antenna array 12, and d_{R} represents a receive antenna spacing or inter-element spacing in a receive antenna array 14; and nₙ(m) represents a noise component.

More particularly, consider a target in the space-time (ST) data matrix with speed v relative to the radar system 10 and direction-of-arrival (DOA) θ. The received ST data matrix xₙ(m, k; v, θ) due to the n-th transmit (Tx) antenna 12, k-th pulse, and m-th receive (Rx) antenna 14 may be defined by Equation (12):

xₙ(m,k;v,θ)=αe^{-j2πf}^{_{c}}^{(n-1)d}^{_{T}}^{sin(θ)/c}e^{-j2πf}^{_{c}}^{(m-1)d}^{_{R}}^{sin(θ)/c}e^{-j2πf}^{_{c}}^{2vt}^{ₙ}^{(k)/c} (12)

where tₙ(k) represents a Doppler sampling time instance corresponding to the k-th pulse of the n-th transmit (Tx) antenna 12. Stacking data from the receive (Rx) antenna 14 and ignoring the noise, Equation (13) may be obtained:

$${x}_{n} ( m ; v , θ ) = α [ \begin{matrix}{e}^{- j 2 π {f}_{c} 2 v {t}_{n} ( 1 ) / c} \\ {e}^{- j 2 π {f}_{c} 2 v {t}_{n} ( 2 ) / c} \\ ⋮ \\ {e}^{- j 2 π {f}_{c} 2 v {t}_{n} ( {N}_{p} 1 ) / c}\end{matrix} ] {e}^{- j 2 π {f}_{c} ( n - 1 ) {d}_{T} s i n ( θ ) / c} {e}^{- j 2 π {f}_{c} ( m - 1 ) {d}_{R} s i n ( θ ) / c} . \qquad ( 13 )$$

Generalizing this data model to Q targets gives the signal model in a vector represented by Equation (9) above. The ST data matrix for n-th transmit (Tx) antenna 12 may be represented as [xₙ(1), . . . , xₙ(M)].

An eigenspace-based method may then be adopted to estimate Doppler from ST matrix in the present embodiment. Accordingly, at step 104, a covariance matrix R may be estimated from the space-time data matrix, the covariance matrix R being represented by Equation (14):

$$R = \frac{1}{M} {\sum }_{m = 1}^{M} {x}_{n} ( m ) {{x}_{n} ( m )}^{H} \qquad ( 14 )$$

where M represents a total number of receive antenna elements; and H represents a conjugate transpose. The signal sample covariance matrix may be estimated using Equation (14) above.

Because the dimension of the Rx array may be limited if the antenna array size is relatively small, a more accurate estimate of the covariance matrix R may be obtained based on the concept of temporal domain smoothing. Accordingly, the covariance matrix R may be estimated using a smoothing process to obtain a smoothened covariance matrix R as defined by Equation (15):

\tilde{R}=(R_{f}+R_{b})/2 (15)

where R_{f} represents a forward-smoothened covariance matrix defined by Equation (16):

$${R}_{f} = \frac{1}{{L}_{f} + 1} {\sum }_{l = 1}^{{L}_{f} + 1} {R}_{l}^{f} \qquad ( 16 )$$

where l represents a smoothing index, L_{f} represents an order of forward smoothing, and Rₗ^{f} is defined by Equation (17):

$${R}_{l}^{f} = \frac{1}{M} {\sum }_{m = 1}^{M} {x}_{n} ( 2 ( l - 1 ) + 1 : 2 ( l - 1 ) + {N}_{s} , m ) {{x}_{n} ( 2 ( l - 1 ) + 1 : 2 ( l - 1 ) + {N}_{S} , m )}^{H} \qquad ( 17 )$$

where the operation A:B means all the integer values from A to B have a step size of 1; Nₛ represents a data length for smoothing; R_{b} represents a backward-smoothened covariance matrix defined by Equation (18):

$${R}_{b} = \frac{1}{{L}_{b} + 1} {\sum }_{l = 1}^{{L}_{b} + 1} {R}_{l}^{b} \qquad ( 18 )$$

where L_{b} represents an order of backward smoothing, and Rₗ^{b} is defined by Equation (19):

$${R}_{l}^{b} = \frac{1}{M} {\sum }_{m = 1}^{M} \tilde{{x}_{n}} {\tilde{{x}_{n}}}^{H} \qquad ( 19 )$$

where [symbol] is defined by Equation (20):

[symbol]

=conj(xₙ(Nₚ−2(l−1):−1:N_{P}−2(l−1)−Nₛ+1,m)) (20)

where conj(x) represents a complex conjugate of (x).

More particularly, considering sampling time indices in a slow-time pulse domain, for example, the sampling time indices t₁ (k) for k-th pulses of a first transmitter 12 may be represented by Equation (21):

t₁(k)=2(floor(k/2)−1)T₁+2(floor((k−1)/2)−1)T₂ (21)

where floor(x) represents a function that outputs a greatest integer less than or equal to x.

Temporal smoothing requires that the sampling time indices t₁(k) in Equation (21) be transitional-invariant, that is, one subset of the time indices may be obtained from another subset by adding or subtracting a constant value. By scrutinizing the data structure of time indices in Equation (21), it is observed that it is transitional-invariant if one data sample is skipped. This implies that data from the following set of sampling indices are transitional-invariant: {tₙ(1) tₙ(2) tₙ(3) . . . tₙ(Nₚ−2)}{tₙ(3) tₙ(4) tₙ(5) . . . tₙ(Nₚ)}. Thus, smoothing may be performed by shifting the data by two (2) samples. Forward-backward smoothing may be applied to conduct the smoothing processing.

Suppose the order of forward smoothing is L_{f}, then 2L_{f}+Nₛ=Nₚ, where Nₛ is the data length for smoothing. For l=1, . . . , L_{f}+1, the covariance matrix may be estimated by Equation (16) above. Similarly, for backward smoothing, the covariance matrix may be estimated by Equation (18) above. Accordingly, the final estimate of the covariance matrix may be represented by Equation (15) above.

At step 106, Eigenvalue decomposition of the smoothened covariance matrix \tilde{R} may be performed using Equation (22) to determine an Eigenvalue distribution:

\tilde{R}=U∧U^{H} (22)

where U represents a matrix whose columns are eigenvectors of \tilde{R}; ∧ represents a diagonal matrix consisting of eigenvalues of \tilde{R}; and U^{H} represents the conjugate transpose of U.

From the Eigenvalue distribution, a number of targets is estimated and a noise-subspace Uₙ may be constructed or determined at step 108.

At step 110, a spectrum P(v) of the Doppler velocity as defined by Equation (23) is estimated:

$$P ( v ) = \frac{1}{{\tilde{u}}_{n} ( v ) {U}_{n} {U}_{n}^{H} {{\tilde{u}}_{n} ( v )}^{H}} \qquad ( 23 )$$

where v represents the Doppler velocity under test; ũₙ(v) represents the Doppler steering vector after smoothing and is represented by Equation (24):

ũₙ(v)=uₙ(1:Nₛ;v) (24)

where uₙ(1: Nₛ; v) represents a first Nₛ rows in a vector of uₙ(v); Uₙ represents a noise subspace; Uₙ^{H} represents the conjugate transpose of the noise subspace; and ũₙ(v)^{H} represents the conjugate transpose of the Doppler steering vector after smoothing. The Doppler processing method 100 exploits the TDM staggered PRF transmit scheme for velocity estimation.

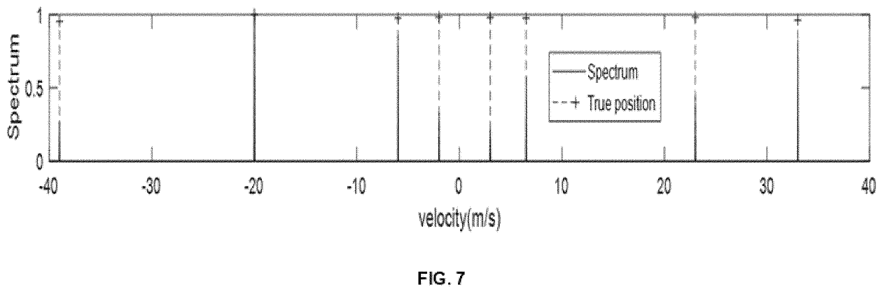

Referring now to FIG. 7, estimation results from the Doppler processing method 100 of FIG. 6 are shown.

Advantageously, the Doppler processing method 100 directly estimates velocity with an extended maximum velocity range. Further advantageously, spatial domain data (i.e., multiple snapshots) may be used in the Doppler processing method 100 so that coherent processing may be conducted on the receive antenna array 14 and maximum coherent gain may thus be achieved. Super resolution may also be achieved with improved performance attributed to the smoothing processing that exploits the transitional-invariant nature of the pulsing scheme.

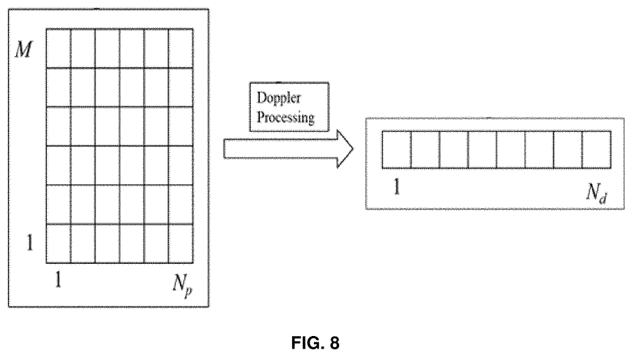

Referring now to FIG. 8, data flow during the Doppler processing step 56 of FIG. 3 is shown. As can be seen from FIG. 8, the Doppler processing step 56 transforms an ST data matrix of dimension M×Nₚ into a Doppler data array.

Referring again to FIG. 5, the Doppler processing is performed on the ST data matrix. For each range cell, the Doppler processing on the ST data matrix leads to a Doppler data array of length N_{d}. After Doppler processing for every range cell, a range-Doppler (RD) map is formed or obtained for each Tx antenna 12.

Referring again to FIG. 3, the RD maps of the transmit antennas 12 are integrated at step 58 to generate an integrated RD map. More particularly, in order to perform detection in the range-Doppler domain, a data cube formed by all range-Doppler maps from all the Tx antennas 12 is integrated to reduce noise and enhance detection performance. At step 58, incoherent integration may be performed by summing up squared magnitudes. After integration, a final RD map is obtained and used later for detection.

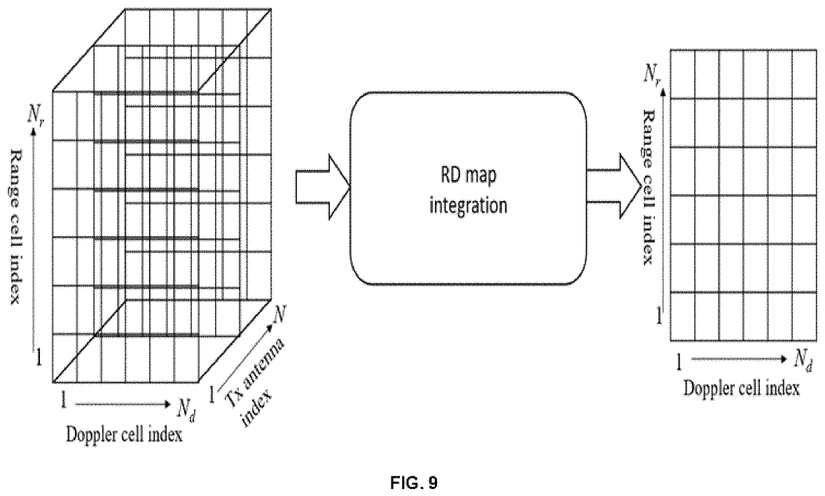

Referring now to FIG. 9, data flow during the step of range-Doppler (RD) integration 58 in the radar target detection method 50 of FIG. 3 is shown. After range-Doppler processing, the initial data cube of dimensions Nᵣ×N_{d}×N consisting of N RD maps turns into a range-Doppler map of size Nᵣ×N_{d} for each Tx antenna 12. RD map integration on the data cube is conducted for every range-Doppler bin over all the RD maps.

In the embodiment shown, N RD maps are integrated because for each Tx antenna 12, data from all M receive channels 14 are coherently processed. Consequently, higher coherent processing gain may be achieved, from which RD detection and range/velocity estimate benefit.

Referring again to FIG. 3, presence of a target is detected from the integrated RD map at step 60. More particularly, based on the integrated RD map, detection is carried out to determine the presence of the target at the range-Doppler cell of interest. Known constant false alarm rate (CFAR) methods may be used for RD detection at step 60.

A range and a velocity of the detected target are estimated at step 62 as detection yields information and/or estimates of the range and the Doppler velocity of the target.

After RD detection and range/velocity estimation, angle estimation is carried out on every detected range-Doppler cell. At step 64, a direction-of-arrival (DOA) of the detected target is estimated. Based on the range and Doppler information of each target, data in a spatial domain corresponding to a virtual antenna array may be used for angle estimation at step 64.

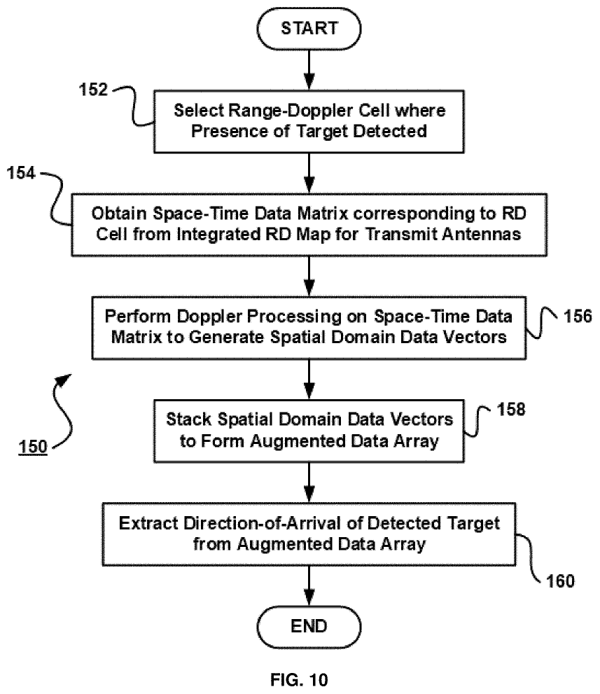

Referring now to FIG. 10, a method 150 for estimating a direction-of-arrival (DOA) of a detected target is shown. The method 150 begins at step 152 by selecting a range-Doppler (RD) cell where the presence of the target has been detected.

Corresponding to this range, a space-time data matrix is chosen from the data cube associated with every Tx antenna 12. Accordingly, a space-time data matrix corresponding to the RD cell from the integrated RD map for the transmit antennas may be obtained at step 154. A data cube obtained at step 154 may include multiple space-time data matrices from different transmit antennas 112 and for the same range.

At step 156, Doppler processing may be performed on the space-time data matrix to generate a plurality of spatial domain data vectors. More particularly, Doppler processing is performed with respect to the Doppler information for each data matrix to generate the spatial domain data vectors. For each space-time data matrix, a discrete-time Fourier transform (DFT) may be performed to retrieve phase information of the signal at every Rx antenna 14. From Equation (12), the signal after integrating all Nₚ pulses may be represented by Equation (25):

yₙₘ(θ)=Σₖ₌₁^{N}^{ₚ}xₙ(m,k;v,θ)e^{j2πf}^{_{c}}^{2vt}^{ₙ}^{(k)/c} (25)

The result for each data matrix is one spatial domain data vector, which is of the same size as the receive array 14 and contains phase information from the corresponding transmit antenna 12. For every data cube, DFT processing generates one data array of size M×1.

The spatial domain data vectors may be stacked at step 158 to form an augmented data array. In the present embodiment, all N data arrays may be stacked to obtain an augmented virtual array of size NM×1 as represented by Equation (26):

y(θ)=[y₁₁(θ) . . . y_{NM}(θ)]^{T} (26)

At step 160, the DOA or angle of the detected target may be extracted from the augmented data array. The DOA may be extracted from the augmented data array using a known high-resolution DOA estimation method. In alternative embodiments, fast Fourier transform (FFT) may also be used to estimate the angle in a ULA virtual array.

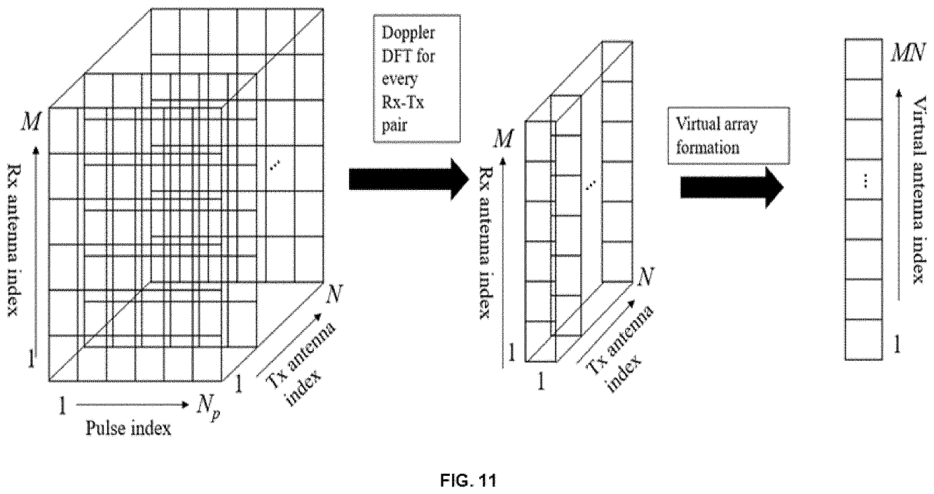

Referring now to FIG. 11, data flow during the DOA estimation method 150 of FIG. 10 is shown. The DOA estimation method 150 begins with a data cube of dimensions M×Nₚ×N containing all the data from one (1) range bin. Doppler discrete-time Fourier transform (DFT) is then conducted for every Tx-Rx pair on the data array of size 1×Nₚ. This converts the data cube into a data matrix of size M×N. Virtual array formation is then performed to generate an array of size MN×1 for DOA estimation.

Referring again to FIG. 3, a point cloud of the detected target is generated at step 66 by computing Cartesian coordinates of the detected target from the range and the DOA of the detected target. More particularly, after obtaining the angle estimate for the range-Doppler cell, the point cloud may be generated by converting the range and angle of the target into a three-dimensional (3D) Cartesian coordinate system. Advanced radar processing may be carried out with the point cloud obtained in step 66. Based on point clouds, other functionalities may be performed, for example, tracking and classification on the point cloud is possible after compensating for platform motion.

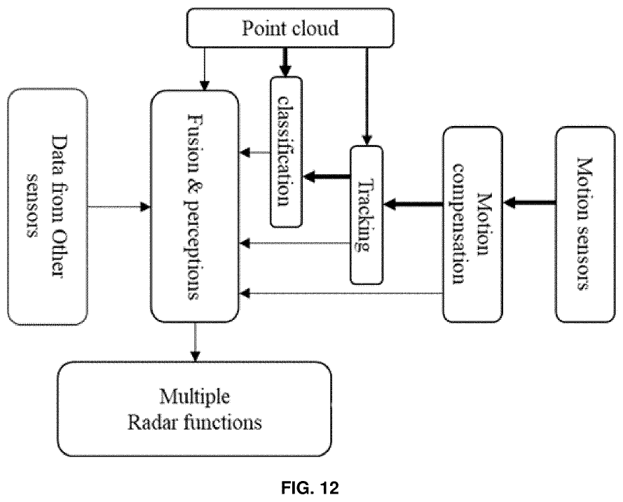

Referring now to FIG. 12, various functionalities of the radar system 10 of FIG. 1 are shown. Applications that directly exploit the point cloud from different radar frames are target tracking and classification. Target tracking may be improved by leveraging information on vehicle motion available from motion sensors. Compensating for vehicular motion improves both tracking and classification. Furthermore, data from other sensors, data fusion and high-level perception are possible to support more advanced and specific radar functions for various applications such as free space detection. Radar functionality thus includes, but is not limited to, target classification, tracking, data fusion and perception, as well as other advanced radar functions such as occupancy grid mapping and free space detection.

As is evident from the foregoing discussion, the present invention provides a radar system and a computer-implemented method for radar target detection that is able to achieve a high-resolution estimate of the Doppler velocity of a target beyond conventional maximum unambiguous limits. The present invention provides a high-resolution FMCW radar system with improved maximum measurable velocity and super-resolution capability in estimating the velocity of a target. Advantageously, the use of staggered PRF in one frame enhances the maximum unambiguous velocity in MIMO radar. The PRF varies on a pulse-by-pulse basis with respect to each transmit antenna of the MIMO radar. Further advantageously, the present invention employs a dual-staggered PRF co-pulsing scheme along with a super-resolution Doppler estimation method. The present invention estimates the true velocity directly with super-resolution methods. The present invention also does not constrain the antenna array configuration or require multiple integrated circuits (ICs) for the transmit and receive systems. The present invention further estimates Doppler over a single frame, thereby increasing the frame-rate. Further advantageously, maximum unambiguous velocity is determined in the present invention by pulse repetition interval (PRI) difference, thereby leading to a flexible implementation.

The present invention may be applied to any FMCW radar such as those used on automotive vehicles and other airborne systems.

While preferred embodiments of the invention have been illustrated and described, it will be clear that the invention is not limited to the described embodiments only. Numerous modifications, changes, variations, substitutions and equivalents will be apparent to those skilled in the art without departing from the scope of the invention as described in the claims. For example, the receiver mixer may be changed or removed. The Tx antenna array and the Rx antenna array may also be modified by adding or removing antenna elements in the Tx and Rx, changing the ULA into other array configurations such as, for example, a non-uniform linear array or changing the one-dimensional (1D) array into two-dimensional (2D) array. When a 2D uniform rectangular array is used, a 2D beamforming method such as 2D FFT may be used to estimate both azimuth and elevation angles.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to.”

What is claimed is:

1. A computer-implemented method for radar target detection, comprising executing via one or more processors:
transmitting a signal from a plurality of transmit antennas to a plurality of receive antennas, each of the transmit antennas being configured to alternately transmit at a first pulse repetition frequency (PRF) and a second PRF, each frame of the signal comprising a number of sub-frames, each sub-frame comprising a plurality of pulses from respective ones of the transmit antennas in a staggered arrangement;
performing range compression on the pulses in each frame of the signal received by the receive antennas to generate a plurality of range cells;
performing Doppler processing on each of the range cells to generate a plurality of range-Doppler (RD) maps for respective ones of the transmit antennas;
integrating the RD maps of the transmit antennas to generate an integrated RD map;
detecting presence of a target from the integrated RD map;
estimating a range and a velocity of the detected target;
estimating a direction-of-arrival (DOA) of the detected target; and
generating a point cloud of the detected target by computing Cartesian coordinates of the detected target from the range and the DOA of the detected target.

2. The computer-implemented method for radar target detection according to claim 1, wherein the number of sub-frames Nₚ in each frame of the signal is determined by Equation (8):
$${N}_{p} = \frac{λ}{N {σ}_{v} ( {T}_{1} + {T}_{2} )} \qquad ( 8 )$$
wherein
λ represents a wavelength of the signal;
N represents a total number of transmit antenna elements;
σᵥ represents a predetermined Doppler resolution;
T₁ represents a first pulse repetition interval (PRI) of the first PRF; and
T₂ represents a second PRI of the second PRF.

3. The computer-implemented method for radar target detection according to claim 2, wherein performing Doppler processing on each of the range cells comprises:
receiving a space-time data matrix xₙ(m) of each of the range cells as represented by Equation (9):
$${x}_{n} ( m ) = [ {u}_{n} ( {v}_{1} ) … {u}_{n} ( {v}_{Q} ) ] [ \begin{matrix}{s}_{n} ( m , {θ}_{1} ) \\ ⋮ \\ {s}_{n} ( m , {θ}_{Q} )\end{matrix} ] + {n}_{n} ( m ) \qquad ( 9 )$$
wherein
n represents an n-th transmit antenna;
m represents an m-th receive antenna;
Q represents a Q-th target;
uₙ(v_{Q}) represents a Doppler steering vector and is defined by Equation (10):
$${u}_{n} ( {v}_{Q} ) = [ \begin{matrix}{e}^{- j 2 π {f}_{c} 2 {v}_{Q} {t}_{n} ( 1 ) / c} \\ {e}^{- j 2 π {f}_{c} 2 {v}_{Q} {t}_{n} ( 2 ) / c} \\ ⋮ \\ {e}^{- j 2 π {f}_{c} 2 {v}_{Q} {t}_{n} ( {N}_{p} - 1 ) / c}\end{matrix} ] \qquad ( 10 )$$
wherein
v_{Q} represents a Doppler velocity of the target,
j represents an imaginary unit,
f_{c} represents carrier frequency,
tₙ represents a Doppler sampling instant, and
c represents a speed of light;
sₙ(m, θ_{Q}) represents a target signal waveform and is defined by Equation (11):
sₙ(m,θ_{Q})=α_{Q}e^{-j2πf}^{_{c}}^{(n-1)d}^{_{T}}^{sin(θ}^{_{q}}^{)/c}e^{-j2πf}^{_{c}}^{(m-1)d}^{_{R}}^{sin(θ}^{_{q}}^{)/c} (11)
wherein
θ_{Q} represents the DOA of the target,
α_{Q} represents a complex amplitude of the target,
d_{T} represents a transmit antenna spacing, and
d_{R} represents a receive antenna spacing; and
nₙ(m) represents a noise component.

4. The computer-implemented method for radar target detection according to claim 3, wherein performing Doppler processing on each of the range cells further comprises:
estimating a covariance matrix R from the space-time data matrix, the covariance matrix R being represented by Equation (14):
$$R = \frac{1}{M} {\sum }_{m = 1}^{M} {x}_{n} ( m ) {{x}_{n} ( m )}^{H} \qquad ( 14 )$$
wherein
M represents a total number of receive antenna elements; and
H represents a conjugate transpose.

5. The computer-implemented method for radar target detection according to claim 4, wherein the covariance matrix R is estimated using a smoothing process to obtain a smoothened covariance matrix \tilde{R} as defined by Equation (15):
\tilde{R}=(R_{f}+R_{b})/2 (15)
wherein
R_{f} represents a forward-smoothened covariance matrix defined by Equation (16):
$${R}_{f} = \frac{1}{{L}_{f} + 1} {\sum }_{l = 1}^{{L}_{f} + 1} {R}_{l}^{f} \qquad ( 16 )$$
wherein
l represents a smoothing index,
L_{f} represents an order of forward smoothing, and
Rₗ^{f} is defined by Equation (17):
$${R}_{l}^{f} = \frac{1}{M} {\sum }_{m = 1}^{M} {x}_{n} ( 2 ( l - 1 ) + 1 : 2 ( l - 1 ) + {N}_{S} , m ) {{x}_{n} ( 2 ( l - 1 ) + 1 : 2 ( l - 1 ) + {N}_{S} , m )}^{H} \qquad ( 17 )$$
wherein
Nₛ represents a data length for smoothing;
R_{b} represents a backward-smoothened covariance matrix defined by Equation (18):
$${R}_{b} = \frac{1}{{L}_{b} + 1} {\sum }_{l = 1}^{{L}_{b} + 1} {R}_{l}^{b} \qquad ( 18 )$$
wherein
L_{b} represents an order of backward smoothing, and
Rₗ^{b} is defined by Equation (19):
$${R}_{l}^{b} = \frac{1}{M} {\sum }_{m = 1}^{M} \tilde{{x}_{n}} {\tilde{{x}_{n}}}^{H} \qquad ( 19 )$$
wherein [symbol]
is defined by Equation (20): [symbol]
=conj(xₙ(Nₚ−2(l−1):−1:Nₚ−2(l−1)−Nₛ+1,m)) (20)
wherein
conj(x) represents a complex conjugate of (x).

6. The computer-implemented method for radar target detection according to claim 5, wherein performing Doppler processing on each of the range cells further comprises:
performing Eigenvalue decomposition of the smoothened covariance matrix \tilde{R} using Equation (22) to determine an Eigenvalue distribution:
\tilde{R}=U∧U^{H} (22)
wherein
U represents a matrix whose columns are eigenvectors of \tilde{R};
∧ represents a diagonal matrix consisting of eigenvalues of \tilde{R}; and
U^{H} represents the conjugate transpose of U.

7. The computer-implemented method for radar target detection according to claim 6, wherein performing Doppler processing on each of the range cells further comprises:
estimating a number of targets and determining a noise-subspace Uₙ from the Eigenvalue distribution.

8. The computer-implemented method for radar target detection according to claim 7, wherein performing Doppler processing on each of the range cells further comprises:
estimating a spectrum P(v) of the Doppler velocity as defined by Equation (23):
$$P ( v ) = \frac{1}{{\tilde{u}}_{n} ( v ) {U}_{n} {U}_{n}^{H} {{\tilde{u}}_{n} ( v )}^{H}} \qquad ( 23 )$$
wherein
v represents the Doppler velocity under test;
ũₙ(v) represents the Doppler steering vector after smoothing and is represented by Equation (24):
ũₙ(v)=uₙ(1:Nₛ;v) (24)
wherein
uₙ(1: Nₛ; v) represents a first Nₛ rows in a vector of uₙ(v);
Uₙ represents a noise subspace;
Uₙ^{H} represents the transpose conjugate of the noise subspace; and
ũₙ(v)^{H} represents the transpose conjugate of the Doppler steering vector after smoothing.

9. The computer-implemented method for radar target detection according to claim 1, wherein estimating the DOA of the detected target comprises:
selecting a range-Doppler (RD) cell where the presence of the target has been detected; and
obtaining a space-time data matrix corresponding to the RD cell from the integrated RD map for the transmit antennas.

10. The computer-implemented method for radar target detection according to claim 9, wherein estimating the DOA of the detected target further comprises:
performing Doppler processing on the space-time data matrix to generate a plurality of spatial domain data vectors.

11. The computer-implemented method for radar target detection according to claim 10, wherein estimating the DOA of the detected target further comprises:
stacking the spatial domain data vectors to form an augmented data array; and
extracting the DOA of the detected target from the augmented data array.

12. A radar system, comprising:
a plurality of transmit antennas;
a plurality of receive antennas, wherein the transmit antennas are configured to transmit a signal to the receive antennas, each of the transmit antennas being configured to alternately transmit at a first pulse repetition frequency (PRF) and a second PRF, each frame of the signal comprising a number of sub-frames, each sub-frame comprising a plurality of pulses from respective ones of the transmit antennas in a staggered arrangement;
one or more processors;
a non-transitory computer-readable memory storing computer program instructions executable by the one or more processors to perform operations for radar target detection, the operations comprising:
performing range compression on the pulses in each frame of the signal received by the receive antennas to generate a plurality of range cells;
performing Doppler processing on each of the range cells to generate a plurality of range-Doppler (RD) maps for respective ones of the transmit antennas;
integrating the RD maps of the transmit antennas to generate an integrated RD map;
detecting presence of a target from the integrated RD map;
estimating a range and a velocity of the detected target;
estimating a direction-of-arrival (DOA) of the detected target; and
generating a point cloud of the detected target by computing Cartesian coordinates of the detected target from the range and the DOA of the detected target.

13. The radar system according to claim 12, wherein the number of sub-frames Nₚ in each frame of the signal is determined by Equation (8):
$${N}_{p} = \frac{λ}{N {σ}_{v} ( {T}_{1} + {T}_{2} )} \qquad ( 8 )$$
wherein
λ represents a wavelength of the signal;
N represents a total number of transmit antenna elements;
σᵥ represents a predetermined Doppler resolution;
T₁ represents a first pulse repetition interval (PRI) of the first PRF; and
T₂ represents a second PRI of the second PRF.

14. The radar system according to claim 13, wherein the operation of performing Doppler processing on each of the range cells comprises:
receiving a space-time data matrix xₙ(m) of each of the range cells as represented by Equation (9):
$${x}_{n} ( m ) = [ {u}_{n} ( {v}_{1} ) … {u}_{n} ( {v}_{Q} ) ] [ \begin{matrix}{s}_{n} ( m , {θ}_{1} ) \\ ⋮ \\ {s}_{n} ( m , {θ}_{Q} )\end{matrix} ] + {n}_{n} ( m ) \qquad ( 9 )$$
wherein
n represents an n-th transmit antenna;
m represents an m-th receive antenna;
Q represents a Q-th target;
uₙ(v_{Q}) represents a Doppler steering vector and is defined by Equation (10):
$${u}_{n} ( {v}_{Q} ) = [ \begin{matrix}- {e}^{j 2 π {f}_{c} 2 {v}_{Q} {t}_{n} ( 1 ) / c} \\ {e}^{- j 2 π {f}_{c} 2 {v}_{Q} {t}_{n} ( 2 ) / c} \\ ⋮ \\ {e}^{- j 2 π {f}_{c} 2 {v}_{Q} {t}_{n} ( {N}_{p} - 1 ) / c}\end{matrix} ] \qquad ( 10 )$$
wherein
v_{Q} represents a Doppler velocity of the target,
j represents an imaginary unit,
f_{c} represents carrier frequency,
tₙ represents a Doppler sampling instant, and
c represents a speed of light;
sₙ(m, θ_{Q}) represents a target signal waveform and is defined by Equation (11):
sₙ(m,θ_{Q})=α_{Q}e^{-j2πf}^{_{c}}^{(n-1)d}^{_{T}}^{sin(θ}^{_{q}}^{)/c}e^{-j2πf}^{_{c}}^{(m-1)d}^{_{R}}^{sin(θ}^{_{q}}^{)/c} (11)
wherein
θ_{Q} represents the DOA of the target,
α_{Q} represents a complex amplitude of the target,
d_{T} represents a transmit antenna spacing, and
d_{R} represents a receive antenna spacing; and
nₙ(m) represents a noise component.

15. The radar system according to claim 14, wherein the operation of performing Doppler processing on each of the range cells further comprises:
estimating a covariance matrix R from the space-time data matrix, the covariance matrix R being represented by Equation (14):
$$R = \frac{1}{M} {\sum }_{m = 1}^{M} {x}_{n} ( m ) {{x}_{n} ( m )}^{H} \qquad ( 14 )$$
wherein
M represents a total number of receive antenna elements; and
H represents a conjugate transpose.

16. The radar system according to claim 15, wherein the covariance matrix R is estimated using a smoothing process to obtain a smoothened covariance matrix \tilde{R} as defined by Equation (15):
\tilde{R}=(R_{f}+R_{b})/2 (15)
wherein
R_{f} represents a forward-smoothened covariance matrix defined by Equation (16):
$${R}_{f} = \frac{1}{{L}_{f} + 1} {\sum }_{l = 1}^{{L}_{f} + 1} {R}_{l}^{f} \qquad ( 16 )$$
wherein
l represents a smoothing index,
L_{f} represents an order of forward smoothing, and
Rₗ^{f} is defined by Equation (17):
$${R}_{l}^{f} = \frac{1}{M} {\sum }_{m = 1}^{M} {x}_{n} ( 2 ( l - 1 ) + 1 : 2 ( l - 1 ) + {N}_{S} , m ) {{x}_{n} ( 2 ( l - 1 ) + 1 : 2 ( l - 1 ) + {N}_{S} , m )}^{H} \qquad ( 17 )$$
wherein
Nₛ represents a data length for smoothing;
R_{b} represents a backward-smoothened covariance matrix defined by Equation (18):
$${R}_{b} = \frac{1}{{L}_{b} + 1} {\sum }_{l = 1}^{{L}_{b} + 1} {R}_{l}^{b} \qquad ( 18 )$$
wherein
L_{b} represents an order of backward smoothing, and
Rₗ^{b} is defined by Equation (19):
$${R}_{l}^{b} = \frac{1}{M} {\sum }_{m = 1}^{M} \tilde{{x}_{n}} {\tilde{{x}_{n}}}^{H} \qquad ( 19 )$$
wherein [symbol]
is defined by Equation (20): [symbol]
=conj(xₙ(Nₚ−2(l−1):−1:Nₚ−2(l−1)−N_{S}+1,m)) (20)
wherein
conj(x) represents a complex conjugate of (x).

17. The radar system according to claim 16, wherein the operation of performing Doppler processing on each of the range cells further comprises:
performing Eigenvalue decomposition of the smoothened covariance matrix \tilde{R} using Equation (22) to determine an Eigenvalue distribution:
\tilde{R}=U∧U^{H} (22)
wherein
U represents a matrix whose columns are eigenvectors of \tilde{R};
∧ represents a diagonal matrix consisting of eigenvalues of \tilde{R}; and
U^{H} represents the conjugate transpose of U.

18. The radar system according to claim 17, wherein the operation of performing Doppler processing on each of the range cells further comprises:
estimating a number of targets and determining a noise-subspace Uₙ from the Eigenvalue distribution.

19. The radar system according to claim 18, wherein the operation of performing Doppler processing on each of the range cells further comprises:
estimating a spectrum P(v) of the Doppler velocity as defined by Equation (24):
$$P ( v ) = \frac{1}{{\tilde{u}}_{n} ( v ) {U}_{n} {U}_{n}^{H} {{\tilde{u}}_{n} ( v )}^{H}} \qquad ( 23 )$$
wherein
v represents the Doppler velocity under test;
ũₙ(v) represents the Doppler steering vector after smoothing and is represented by Equation (24):
ũₙ(v)=uₙ(1:Nₛ;v) (24)
wherein
uₙ(1: Nₛ; v) represents a first Nₛ rows in a vector of uₙ(v);
Uₙ represents a noise subspace;
Uₙ^{H} represents the transpose conjugate of the noise subspace; and
ũₙ(v)^{H} represents the transpose conjugate of the Doppler steering vector after smoothing.

20. The radar system according to claim 12, wherein the operation of estimating the DOA of the detected target comprises:
selecting a range-Doppler (RD) cell where the presence of the target has been detected; and
obtaining a space-time data matrix corresponding to the RD cell from the integrated RD map for the transmit antennas.

21. The radar system according to claim 20, wherein the operation of estimating the DOA of the detected target further comprises:
performing Doppler processing on the space-time data matrix to generate a plurality of spatial domain data vectors.

22. The radar system according to claim 21, wherein the operation of estimating the DOA of the detected target further comprises:
stacking the spatial domain data vectors to form an augmented data array; and
extracting the DOA of the detected target from the augmented data array.
